(19) United States
(12) Patent Application Publication
(10) Pub. No.: US 2015/0060144 A1
(43) Pub. Date: Mar. 5, 2015

(54) TURBINE BLADE FOR TURBODRILLS

(71) Applicant: SMITH INTERNATIONAL, INC., Houston, TX (US)

(72) Inventors: Weixiong Wang, Houston, TX (US); James Layne Larsen, Spring, TX (US); Lijun Song, Sugar Land, TX (US); Dwayne P. Terracina, Spring, TX (US)

(21) Appl. No.: 14/467,891

(22) Filed: Aug. 25, 2014

Related U.S. Application Data
(60) Provisional application No. 61/870,621, filed on Aug. 27, 2013.

(51) Int. Cl. E21B 3/00; E21B 4/02; F03B 13/02

(52) U.S. Cl. CPC E21B 3/00; F03B 13/02; E21B 4/02
USPC 175/57; 175/92

(57) ABSTRACT

A turbodrill having a housing having a bore extending at least partially therethrough, a rotatable shaft disposed in the housing bore and rotatable relative to the housing, the housing, the housing bore and the rotatable shaft having a common longitudinal axis; and a plurality of turbine blades disposed at least partially within the housing bore, at least one turbine blade of the plurality of turbine blades including a first blade profile disposed at a first point along a blade span and a second blade profile disposed at a second point along the blade span, the second blade profile differing from the first blade profile.

### CROSS-REFERENCE TO RELATED APPLICATIONS

The present application claims priority to U.S. Provisional Application 61/870,621, filed Aug. 27, 2013, the entirety of which is incorporated by reference.

### FIELD OF THE INVENTION

Aspects of the present disclosure relate to downhole drilling systems. More specifically, aspects of the present disclosure relate to turbodrill systems and turbine blades for turbodrill systems.

### BACKGROUND INFORMATION

Turbodrills are used in downhole environments to allow for power transmission to a drill bit. In turbodrill systems, the drill bit may be isolated from the drillstring. Turbodrills convert hydraulic energy from a mud column into mechanical energy at the bit. Turbordrill blades may be impacted by flowing fluid. The impacting fluid is converted to a rotational mechanical energy through the shape of the blade.

By rotating a drive, shaft at a higher rpm while remaining dynamically stable, turbodrills may provide superior rates of penetration into geological stratum without the negative effects of excess torque.

### SUMMARY

Described herein are implementations of various technologies for a turbine blade for turbodrills. In one implementation, a turbodrill may include a housing having a bore extending therethrough. The turbodrill may also include a rotatable shaft disposed in the housing bore. The shaft is rotatable relative to the housing. The housing, the housing bore and the rotatable shaft have a common longitudinal axis. The turbodrill may further include a plurality of turbine blades. At least one turbine blade may include a first blade profile disposed at a first point along a blade span. The at least one turbine blade may also include a second blade profile disposed at a second point along the blade span. In one or more implementations, the second blade profile may differ from the first blade profile.

### BRIEF DESCRIPTION OF THE DRAWINGS

Implementations of various techniques will hereafter be described with reference to the accompanying drawings. It should be understood, however, that the accompanying drawings illustrate various implementations described herein and are not meant to limit the scope of various techniques described herein.

FIG. 1 illustrates a view of a turbodrill in connection with implementations of various techniques described herein.

FIG. 2 illustrates a stator stage of a turbine stage in connection with implementations of various techniques described herein.

FIG. 3 illustrates a rotor stage of a turbine stage in connection with implementations of various techniques described herein.

FIGS. 4-6 illustrate side views of rotor stages in connection with implementations of various techniques described herein.

FIGS. 7-9 illustrate top views of rotor stages in connection with implementations of various techniques described herein.

FIG. 10 illustrates a side view of a rotor stage in accordance with implementations of various techniques described herein.

FIG. 11 illustrates a top view of a rotor stage in accordance with implementations of various techniques described herein.

FIG. 12 illustrates a blade profile with various profile parameters in accordance with implementations of various techniques described herein.

FIG. 13 illustrates a twisted turbine blade in accordance with implementations of various techniques described herein.

FIG. 14 illustrates a twisted turbine blade in accordance with implementations of various techniques described herein.

FIG. 15 illustrates a twisted turbine blade in accordance with implementations of various techniques described herein.

FIG. 16 illustrates a flow separation for a straight turbine blade in accordance with implementations of various techniques described herein.

FIG. 17 illustrates a flow separation for a twisted turbine blade in accordance with implementations of various techniques described herein.

FIG. 18 illustrates comparative graphs of efficiency between straight turbine blades and twisted turbine blades in accordance with implementations of various techniques described herein.

FIG. 19 illustrates a portion of a turbodrill which includes turbine stages having twisted turbine blades in accordance with implementations of various techniques described herein.

### DETAILED DESCRIPTION

The discussion below is directed to certain specific implementations. It is to be understood that the discussion below is for the purpose of enabling a person with ordinary skill in the art to make and use any subject matter defined now or later by the patent “claims” found in any issued patent herein.

It is specifically intended that the claims not be limited to the implementations and illustrations contained herein, but include modified forms of those implementations including portions of the implementations and combinations of elements of different implementations as conic within the scope of the following claims.

Reference will now be made in detail to various implementations, examples of which are illustrated in the accompanying drawings and figures. In the following detailed description, numerous specific details are set forth in order to provide a thorough understanding of the present disclosure it will be apparent to one of ordinary skill in the art that the present disclosure may be practiced without these specific details. In other instances, well-known methods, procedures, components, circuits and networks have not been described in detail so as not to obscure aspects of the embodiments.

It will also be understood that, although the terms first, second, etc. may be used herein to describe various elements, these elements should not be limited by these terms. These terms are used to distinguish one element from another. For example, a first object could be termed a second object, and, similarly, a second object could be termed a first object, without departing, from the scope of the claims. The first object and the second object are both objects, respectively, but they are not to be considered the same object.

The terminology used in the description of the present disclosure herein is for the purpose of describing particular implementations and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses one or more possible combinations of one or more of the associated listed items. It will be further understood that the terms “includes” and/or “including,” when used in this specification, specify the presence of stated features, integers, operations, elements, and/or components, but do not preclude the presence or addition of one or more other features, integers, operations, elements, components and/or groups thereof.

As used herein, the terms “up” and “down;” “upper” and “lower;” “upwardly” and downwardly;” “below” and “above” and other similar terms indicating relative positions above or below a given point or element ma be used in connection with some implementations of various technologies described herein. When applied to equipment and methods for use in wells that are deviated or horizontal, or when applied to equipment and methods that when arranged in a well are in a deviated or horizontal orientation, such terms may refer to a left to right, right to left, or other relationships as appropriate.

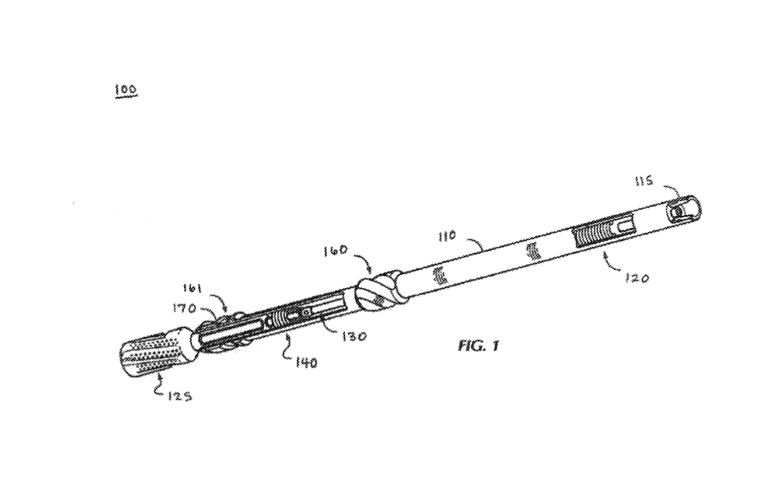

FIG. 1 illustrates a view of a turbodrill 100 in connection with implementations of various techniques described herein. The turbodrill 100 includes a housing 110 having a bore extending at least partially therethrough. The housing 110 includes an uphole connection 115 configured to be coupled to a drill string. Turbine stages 120 are disposed within the housing 110 and may be used to rotate a shaft 130 via drilling fluid/mud pumped at least partially through the bore of the housing 110. At a downhole end portion of the turbodrill 100, a drill bit 125 may be attached to the shaft 130 by a downhole connection (not shown). In addition, stabilizers 160 and 161 may be disposed on the housing 110 to help keep the turbodrill 100 centered within a wellbore.

The turbodrill 100 may use the turbine stages 120 to provide rotational force to the drill bit 125. The turbine stages 120 may include one or more non-moving stator blades and a rotor assembly having rotor blades mechanically linked to the shaft 130. The turbine stages 120 may be designed such that the blades of the stator stages may direct drilling fluid into corresponding rotor blades to provide rotation to the shaft 130, where the shaft 130 ultimately couples to and drives the drill bit 125. Thus, the high-speed drilling fluid flowing into the rotor blades may cause the shaft 130 and the drill bit 125 to rotate with respect to the housing 110. A portion of the turbodrill 100 in which the turbine stages 120 are located may be called a power section, which may also include other components used to drive the drill bit 125.

While providing rotational force to the shaft 130, the turbine stages 120 may also produce a downhole axial force, or thrust, from the drilling fluid. The downhole thrust, however, may produce a higher weight on bit (WOB) than is needed for operation of the turbodrill 100. Uphole axial thrust may also result from reactionary forces of the drill bit 125. To mitigate the effects of excess thrust in the turbodrill 100, one or more thrust bearing assemblies 140 may be provided. The thrust bearings 140 may include steel roller bearings, polycrystalline diamond compact (“PDC”) surface bearings, or any other implementation known to those skilled in the art. The turbodrill 100 may also include radial bearings 170 provided between the shaft 130 and the housing 110, where the radial bearings 170 may help keep the shaft 130 concentric within the housing 110. A portion of the turbodrill 100 in which the thrust bearing assemblies 140 and the radial bearings 170 are located may be called a bearing section.

### Turbine Stage Operation

In operation, drilling fluid (not shown) may be pumped through the drill string until it enters the turbodrill 100. When the drifting fluid enters the turbodrill 100, the flow may be substantially in the axial direction in line with a central axis (not shown) of the turbodrill 100. The drilling fluid may then be diverted from the center of the turbodrill 100 (i.e., bore of the housing 110) to an outer radial position of the turbodrill 100. As mentioned above, the drilling fluid may pass through the turbine stages 120, including one or more suitor stages rotationally fixed relative to the housing 110 and the drill string. A plurality of stator blades may be positioned around each stator stage. As the drilling fluid passes through the stator stages, the drilling fluid may accelerate and the flow direction may be changed by a selected angle, also known as the swirl angle. The resulting flow direction may be helical with respect to the central axis.

After passing through the suitor stages, the drilling fluid may pass through the rotor stages of the turbine stages 120. A plurality of rotor blades may be positioned around the rotor stages. The rotor blades may direct the flow in an opposing direction to the helical flow resulting from the stator stages. The rotor blades may also be shaped similarly to an airfoil so that the drilling fluid passes efficiently through the rotor stages. The energy used to change the rotational direction of the drilling fluid may be transformed into the rotational and axial (thrust) force. This energy transfer may be seen as a pressure drop in the drilling fluid. The rotational force may then cause the rotor stages, the shaft 130, and the drill bit 125 to rotate with respect to the housing 110, as mentioned above.

Turbine stages 120 may be stacked coaxially until the desired power and torque is achieved. Because a pressure drop may result from each turbine stage 120, a total pressure drop may be taken into account when selecting pumps (not shown) used to convey the fluid downhole. The stacking of turbine stages 120 may also increase the overall length of the tool.

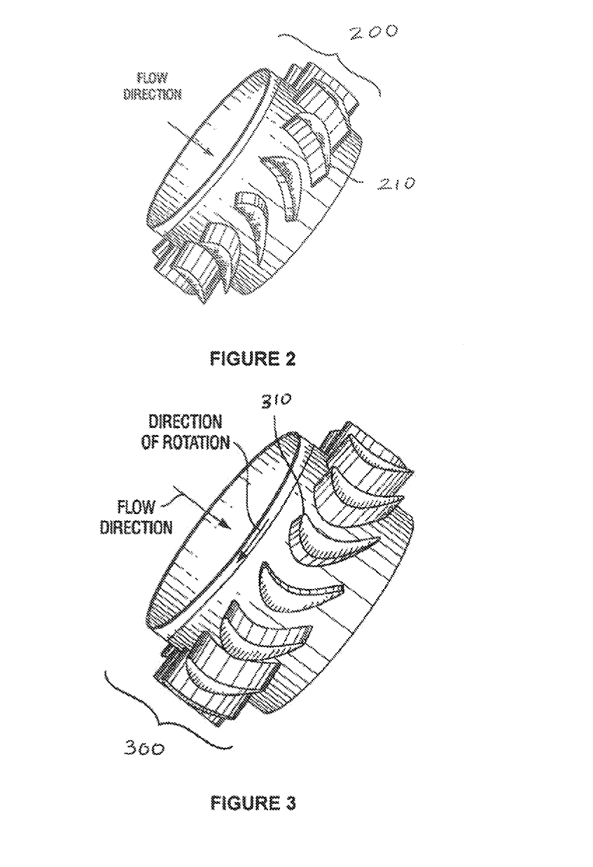

FIG. 2 illustrates a stator stage 200 and FIG. 3 illustrates a rotor stage 300 of a turbine stage 120 in connection with implementations of various techniques described herein. The stator stage 200 may include a plurality of stator blades 210 spaced around a circumference of the stator stage 200. The rotor stage 300 may include a plurality of rotor blades 310 spaced around a circumference of the rotor stage 300. The spacing of the blades on each stage may be substantially equidistant because of the balanced performance that symmetry may provide. The stator stage 200 and the rotor stage 300 may combined to form the turbine stage 120. Rotor blades and/or stator blades may be collectively referred to as turbine blades.

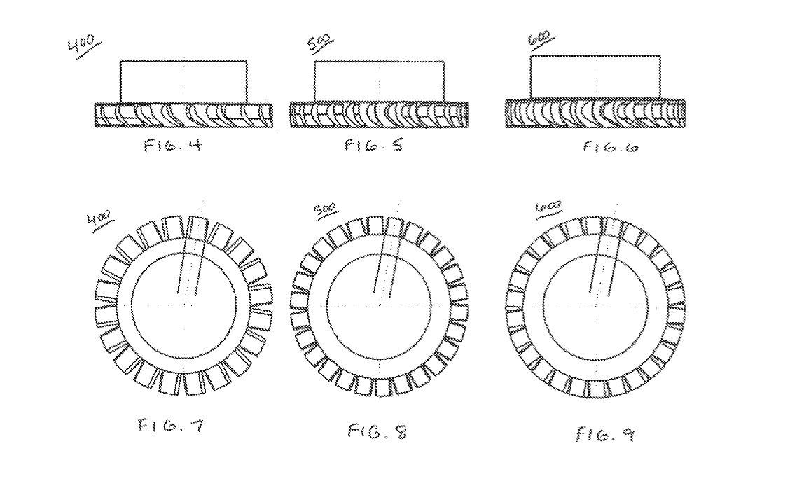

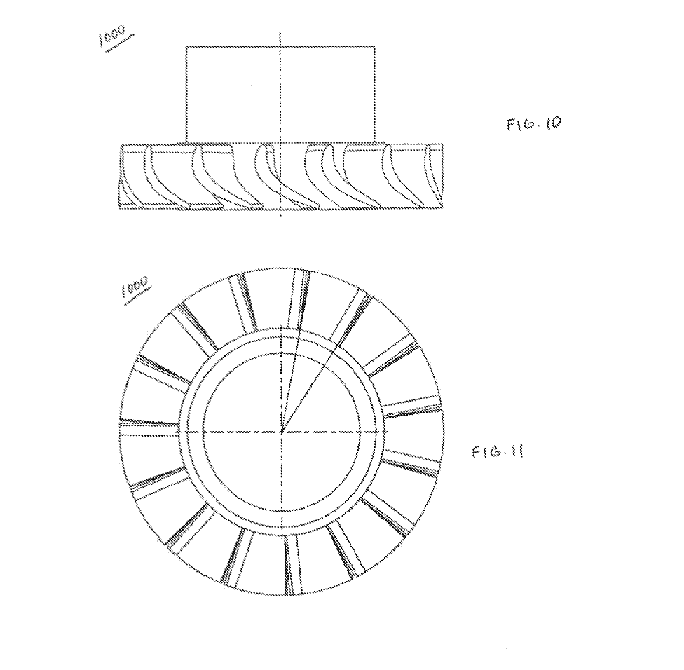

FIGS. 4-6 illustrate side views of rotor stages 400, 500 and 600, respectively, in connection with implementations of various techniques described herein. The stator stages of FIGS. 4-6 may each include a plurality of rotor blades. FIGS. 7-9 illustrate top views of the rotor stages 400, 500 and 600, respectively, including respective pluralities of rotor blades, in connection with implementations of various techniques described herein.

### Turbine Blades

In one implementation, a turbodrill, e.g., turbodrill 100, may use one or more twisted turbine blades. A twisted turbine blade may be a turbine blade having two or more blade profiles which differ in terms of profile parameters and/or are oriented differently using profile stacking. The twisted turbine blade may be either a stator blade or rotor blade. FIG. 10 illustrates a side view and Figure ii illustrates a top view of a rotor stage 1000 in accordance with implementations of various techniques described herein. The rotor stage 1000 may have a plurality of twisted rotor blades, as shown in the figures.

A blade profile may be defined as a three-dimensional (3D), cross-sectional curved surface of a turbine blade formed by an intersection of an imaginary cylinder with the turbine blade, where the imaginary cylinder may be concentric to a central axis of a turbodrill which contains the turbine blade. The intersection of the imaginary cylinder and the turbine blade may occur at a spanwise direction of the turbine blade, where spanwise may be defined as being in a radial direction along the turbine blade and away from the central axis. In such an implementation, points of the blade profile may be located equidistantly from the central axis.

The intersection of the imaginary cylinder and the turbine blade may occur at a profile radius, where the profile radius may be positioned between a hub radius and a shroud radius of the turbine blade. The hub radius of the turbine blade may be defined at the nearest end of the turbine blade from the central axis, and the shroud radius may be defined at the farthest end of the turbine blade from the central axis.

In one implementation, a twisted rotor blade may be used to account for differing rotating velocities along a spanwise direction of the rotor blade. A rotor blade may experience its lowest rotating velocity at the huh radius while experiencing its highest rotating velocity at its shroud radius, with the rotating velocity increasing between the two end portions of the rotor blade. The twisted rotor blade may use multiple blade profiles which differ in terms of profile parameters and/or are oriented differently using profile stacking; in order to compensate for the varying rotating velocities along a spanwise direction of the rotor blade.

### Profile Parameters

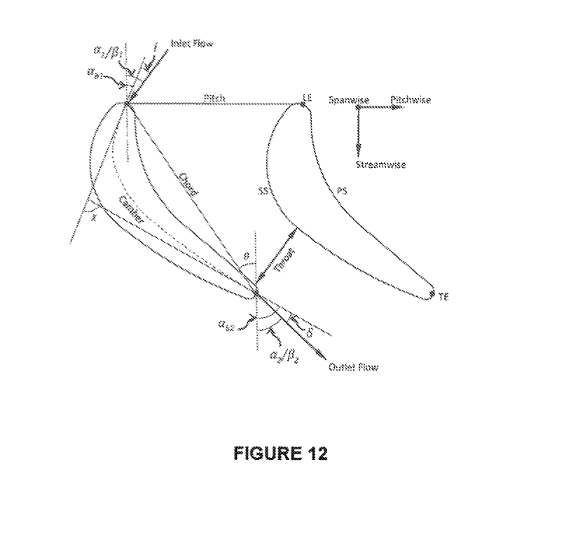

FIG. 12 illustrates a blade profile with various profile parameters in accordance with implementations of various techniques described herein. The blade profile as illustrated may be formed by an intersection of an imaginary cylinder and the turbine blade as described earlier, and then transposed into a two-dimensional (2D) plane, as shown in FIG. 12. An x-axis of the 2D plane may represent radius values multiplied by theta angles (as will be described later), while the y-axis may represent Z coordinates. After being transposed, the resulting blade profile may retain the same shape, lengths, area and/or profile parameter values as the blade profile before being transposed. In addition, the resulting blade profile may take the form of an airfoil.

Various profile parameters will now be described with reference to FIG. 12. For example, a camber of the turbine blade may represent a base line or skeleton of the blade profile. A thickness t may be distributed over the camber. A chord may be a straight line connecting two ends of the camber. A leading edge (LE) of the turbine blade may be the most upstream line of the blade. A trailing edge (TE) of the turbine blade may be the most downstream line of the blade. Blade profiles of a turbine blade may be connected at their respective leading edges and their respective trailing edges to form the leading edge and trailing edge of the turbine blade. In particular, the flow of drilling fluid may contact a leading edge of a turbine blade and become redirected by the turbine blade into another direction. A tip of the turbine blade may represent the furthest end portion of the blade from a central axis running through the turbodrill (i.e., at the shroud radius). A root of the turbine blade may represent the nearest end portion of the blade from the central axis (i.e., at the hub radius).

Further, a pressure surface (PS) of the turbine blade may be concave-shaped, while a suction surface (SS) may be convex-shaped. A height of the turbine blade may be a radial distance from the root to the tip of the turbine blade. A pitch of the turbine blade may be a tangential distance between two consecutive turbine blades. A stagger angle may be an angle formed between the chord and the central axis. A theta angle may be a tangential coordinate of the turbine blade in a cylindrical coordinate system, where the cylindrical coordinate system may use radial coordinates, tangential coordinates, and axial coordinates. A throat of the turbine blade may be a minimum area in the passage between two consecutive turbine blades, where the passage may be adjacent to the trailing edge in subsonic blades. A blade span may be a radial position on the turbine blade starting from 0% at root to 100% at tip. Spanwise may be a radial direction along a blade height, as described earlier. A streamwise direction may be an axial direction that is parallel to the central axis. A pitchwise direction may be a tangential direction or along the blade pitch.

An inlet blade angle of the blade profile may be an angle formed between the camber and the central axis at the leading edge. Further, an inlet flow angle may be the angle formed between an inlet flow direction and the central axis at the leading edge An outlet blade angle may be an angle formed between the camber and the central axis at the trailing edge. An outlet flow angle may be an angle formed between an outlet flow direction and the central axis at the trailing edge. An incidence angle may be an angle defined by a difference between the inlet flow angle and the inlet blade angle. A deviation angle may be an angle defined by the difference between the outlet flow angle and the outlet blade angle. A camber angle may be an angle defined by the difference between the inlet blade angle and the outlet blade angle. The deflection angle may be an angle defined by the difference between the inlet flow angle and the outlet flow angle.

In a twisted turbine blade, one or more of the parameters described above may be used to differentiate one blade profile from another blade profile within the same turbine blade. For example, a first blade profile may be designed to have a smaller thickness than a second blade profile within the same turbine blade. Such a turbine blade may produce a twisted configuration for the turbine blade, as will be described later.

In designing a twisted rotor blade, two or more blade profiles may be designed initially based on the above-described profile parameters. In particular, the rotor blade may be designed by customer requirements. For example, customer requirements may specify the following: hub radius (R_{Hub}) measured in meters, shroud radius (R_{Shroud}) measured in m, flow rate (Q) measured in m³/seconds (s), mud weight (ρ) measured in kilograms (kg)/m³, operating speed (ω) measured in radians/s, stall torque (T_{Stall}) measured in N-m (newton-meters) and maximum tool length (L_{Tool}) measured in m. Based on such customer requirements, the above-described profile parameters may be determined.

Further, in one process for designing the twisted rotor blade, upon receiving-the customer requirements, a number of turbine stages N may be determined using the following equation:

$$N = \frac{{T}_{Stall}}{ψ ρ Q ω ( {R}_{Hub}^{2} + {R}_{Shroud}^{2} )} .$$

Turbine stages N, as described earlier, may include a combination of stator and rotor stages.

In the above equation, ψ is the overall loading coefficient and may be chosen to be about 1.0 for each blade profile of the rotor blades, as described below. Upon determining N, a number of layers n (n≧2) may be determined. Each layer may have its own independent blade profile. A radius of the blade profile at the i^{th} layer may be defined using the following equation:

$${r}_{i} = {R}_{hub} + \frac{i - 1}{n - 1} ( {R}_{Shroud} - {R}_{hub} ) , \\ ( 1 \leq i \leq n ) .$$

For each layer, a local loading coefficient ψᵢ and a flow coefficient φᵢ may be calculated with the following equations:

$${ψ}_{i} = \frac{{T}_{Stall}}{2 N ρ Q ω {r}_{i}^{2}}$$

$${φ}_{i} = \frac{Q}{π ω {r}_{i} ( {R}_{Shroud}^{2} - {R}_{Hub}^{2} )}$$

As noted earlier, the local loading coefficient for each blade profile may be designed to be about 1.0. Thus, the loading coefficient along the entire turbine blade may be about 1.0. The loading coefficient may be used to define a ratio between export rotor power and dynamic pressure for a rotor blade stage. In some implementations, the loading coefficient may be designed to be about 1.0 in order to export certain rotor power, regardless of limits to input power provided to the rotor blade stage. As the loading coefficient is inversely proportional to the operating speed for rotating velocity) of the rotor blade and the flow rate, stall torque may be increased in order to compensate, while keeping efficiency of the turbodrill in mind. Given that rotating velocities may change along the span of the rotor blade, the parameters used to achieve a loading coefficient of around 1.0 for each blade profile may also change. Based on each blade profile's changing parameters, the overall rotor blade may be designed.

Upon determining the local loading coefficient ψᵢ and the flow coefficient φᵢ for rotor blade profiles on each layer, the inlet blade angle βᵢ₁ and outlet blade angle βᵢ₂ may be calculated using the following equations:

$${β}_{i 1} = {tan}^{- 1} ( \frac{{ψ}_{i} - 2 Λ}{2 {φ}_{i}} ) - {α}_{Att}$$

$${β}_{i 2} = {tan}^{- 1} ( - \frac{{ψ}_{i} + 2 Λ}{2 {φ}_{i}} ) - δ .$$

In the above equations, Λ may be a reaction coefficient and may be chosen to equal around 0.5, i.e., the rotor stages and stator stages may have symmetric blade profile designs. In addition, α_{Att}=0˜2° may be defined as an attack angle at the leading edge and δ=5˜8° may be a deviation angle at the trailing edge. The attack angle at the leading edge may be defined as the difference between the inlet flow angle and the inlet blade angle. A value for the attack and deviation angles may be adjusted and optimized by a computational fluid dynamics (CFD) simulation method, as described later.

In addition, an average blade pitch may be determined using the following equation:

$$s = k \frac{{L}_{Tool}}{2 N} ,$$

where k is a coefficient and may be between around 0.8 to around 1.2. A number of blades per stage B may be calculated using:

$$B = \frac{2 π}{s} \sqrt{\frac{{R}_{Shroud}^{2} + {R}_{hub}^{2}}{2}} .$$

In addition, a chord of a blade profile may be determined by Zweifel's criterion:

$${b}_{i} = \frac{2 {s}_{i}}{{ψ}_{θ}} {{cos}^{2}}_{i 2} \vert tan {β}_{i 1} - tan {β}_{i 2} \vert ,$$

in which sᵢ may be a pitch of a blade profile and may be determined by:

$${s}_{i} = \frac{2 π {r}_{i}}{B} .$$

Upon designing the two or more blade profiles, the CFD simulation method, mentioned earlier, may be used to iteratively optimize the blade profiles and profile stacking, aiming at a higher total efficiency. Other parameter ranges may include a shroud diameter of about 2-10 inches, a hub ratio (R_{hub}/R_{shroud}) of about 60%-85%, an operating speed (or rotating velocity) of about 500-3000 revolutions per minute (rpm), a number of stages of about 50-150, and a number of blades per stage of about 15-40. Upon determining the two or more blade profiles to be used in the twisted turbine blade, one or more profile stacking methods may be employed to finalize design of the turbine blade. In one or more implementations, the number of blade profiles designed may be up to the same as the number of different rotating velocities along the span of the turbine blade.

### Profile Stacking

After the blade profiles at different blade spans are defined, the 3D twisted turbine blade may be generated by stacking those blade profiles. There are multiple ways to perform the profile stacking. Based on the profile stacking method, the degree to which turbine blades can be twisted may depend upon customer requirements, the CFD simulation to be performed and efficiency optimization. As shown below, the turbine blade may be twisted in any number of configurations, including from a leading edge to a trailing edge of the turbine blade.

In one implementation, a turbine blade may be designed using at least three blade profiles: a profile at the hub radius, a profile at the shroud radius, and a profile at a midpoint of the blade span, in other implementations, any number of blade profiles may be used to design the turbine blade. In designing a twisted turbine blade, the three blade profiles may differ, or may be the same, depending on the profile stacking method used. In one implementation, the profile stacking methods may be defined by the alignment of the leading edge and/or the trailing edge of the turbine blades, as described below. The profile stacking method used for a particular turbine blade may depend upon the designed blade profiles and CFD simulations performed using the blade profiles and profile parameters. The CFD simulation may take into account the 3D effects of blade profiles and profile stacking methods.

a. Nonlinear Profile Stacking

In one implementation, nonlinear profile stacking may be used to orient blade profiles in the form of a twisted turbine blade. In nonlinear profile stacking, a leading edge and/or a trailing edge of the turbine blade may be nonlinear. In particular, the leading edge and/or trailing edge may be curved. Further, for nonlinear profile stacking, at least two blade profiles of the twisted turbine blade may have differing stagger angles and/or theta angles, thus orienting the turbine blade into its twisted configuration. The stagger angles of the twisted turbine blade may be designed such that the nonlinear leading edge and nonlinear trailing edge may account for differing rotating velocities along the span of the turbine blade and for an angle of attack of the drilling fluid.

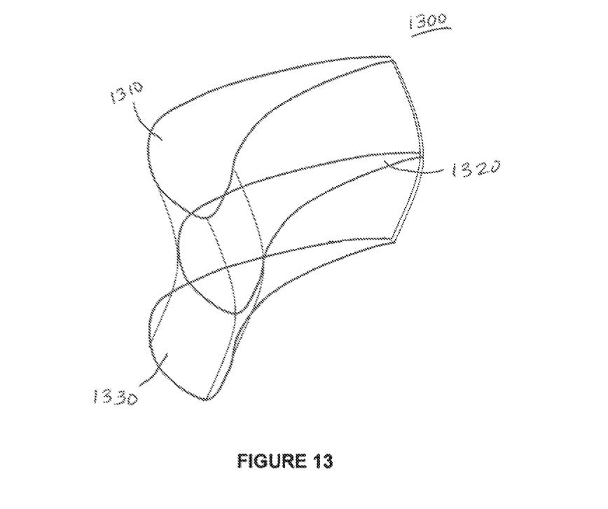

In one such implementation, the leading edge and trailing edge of the twisted turbine blade may each take the form of a curved line, where each blade profile of the twisted turbine blade may have substantially identical profile parameters (other than the stagger angle), as shown in FIG. 13. FIG. 13 illustrates a twisted turbine blade 1300 in accordance with implementations of various techniques described herein. In such an implementation, the curved lines representing the leading edge and the trailing edge may or may not be parallel. If the leading edge and the trailing edge are parallel, then the chord lengths of the blade profiles may be identical throughout the turbine blade.

In FIG. 13, blade profile 1310 and blade profile 1330 may have substantially identical profile parameters (including stagger angle), while blade profile 1320 may differ from the other two blade profiles in terms of its theta angle. This difference in theta angle for the blade profile 1320 may lead to a curved leading edge and curved trailing edge for the twisted turbine blade 1300. In such an implementation, the blade profiles may have substantially equal chord and camber lengths.

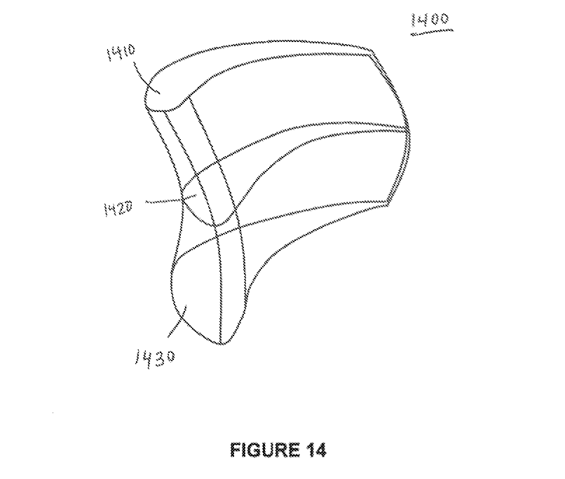

In another implementation, the leading edge and the trailing edge of the twisted turbine blade may each take the form of a curved line, where at least two blade profiles of the twisted turbine blade may differ in terms of profile parameters (including by stagger angle), as shown in FIG. 14. FIG. 14 illustrates a twisted turbine blade 1400 in accordance with implementations of various techniques described herein. In such an implementation, and similar to FIG. 14, the curved lines representing the leading edge and the trailing edge may or may not be parallel.

In FIG. 14, blade profiles 1410, 1420 and 1430 may each differ from the other blade profiles in terms of at least one profile parameter, besides stagger angle. For example, blade profiles 1410, 1420 and 1430 may each differ from the other blade profiles in terms thickness and/or camber lengths. In addition, one or more of the blade profiles 1410, 1420 and 1430 may differ from the other blade profiles in terms of their respective stagger angles, thereby producing the curved leading edge and curved trailing edge for the twisted turbine blade 1400.

In another implementation, where at least two blade profiles of a twisted turbine blade may differ in terms of profile parameters (including by stagger angle), either the leading edge or the trailing may be nonlinear while the other may be linear.

b. Linear Profile Stacking

In one implementation, linear profile stacking may be used to orient blade profiles to form a twisted turbine blade. In linear profile stacking, a leading edge and/or a trailing edge of the turbine blade may be linear. In particular, the leading edge and the trailing edge may each be substantially straight lines, as opposed to curved lines. The twisted configuration of the turbine blade may result from the turbine blade having at least two blade profiles which differ in terms of profile parameters. The at least two blade profiles which differ in terms of profile parameters may be designed such that the linear leading, edge and linear trailing edge may account for differing rotating velocities along the turbine blade and for an angle of attack of the drilling fluid.

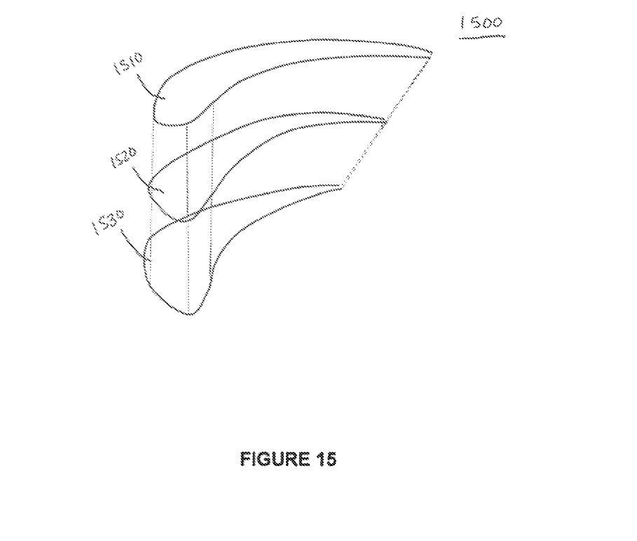

FIG. 15 illustrates a twisted turbine blade 1500 in accordance with implementations of various techniques described herein. In such an implementation, the straight lines representing the leading edge and the trailing edge may or may not be parallel. In one implementation, the leading edge and the trailing edge may be parallel and may be perpendicular to a central axis of a turbodrill.

In FIG. 15, blade profiles 1510, 1520 and 1530 may each differ from the other blade profiles in terms of at least one profile parameter. For example, blade profiles 1510, 1520 and 1530 may each differ from the other blade profiles in terms thickness and/or camber lengths, thereby producing the twisted configuration of the turbine blade 1500. In other implementations, the blade profiles of the turbine blade 1500 may progressively increase in chord lengths, camber lengths and/or thickness from one blade profile to the next blade profile, beginning with a blade profile at either a hub radius or a shroud radius. In the implementation with the increasing chord lengths, the leading edge and the trailing edge may be diverging from one another. In the implementations with the changing camber lengths and/or thickness, the leading edge and the trailing edge may be parallel. In other implementations, profile parameters such as stagger angle and blade exit angle may similarly increase from one blade profile to the next blade profile.

### Benefits of Twisted Blade Design

As shown above, after completing the two or more blade profile designs and using a profile stacking method via 3D CFD, the varying rotating speed along the blade span may be accommodated by the twisted configuration of the turbine blade. In addition, blade efficiency may be improved as a result of reduced flow separation at a shroud radius and/or huh radius. With higher blade efficiency, a total number of blade stages may be reduced based on power requirements of the turbodrill. Accordingly, a length and weight of the turbodrill may be reduced. Blade chord length may also increase along the blade span in a way that its span angle may keep a constant value. Therefore, power export ability may be maintained along the entire blade span. Input power to the turbine stages may be defined as a product of the fluid pressure drop and the flow rate. The output power of the turbine stages may be defined as a product of stall torque and rotating velocity. The blade efficiency may be defined as a ratio of output power to input power.

The twisted turbine blade may be directly machined via 3D computer-aided design (CAD) with sufficient accuracy. As the number of blade profiles designed for a turbine blade increases, the efficiency of the turbine blade may also increase. In addition, various implementations described herein may be designed to accommodate incompressible mud flow. Further, as mentioned above, various implementations described herein may be used for either stator blades or rotor blades, including in both mirrored and non-mirrored configurations. Furthermore, various implementations described herein may be used for turbine blades of multiple turbine stages.

Various implementations described herein may offer improved performance in comparison with a straight turbine blade. A straight turbine blade may be defined as turbine blade having identical blade profiles throughout the blade and having a leading edge and trailing edge in the form of straight, parallel lines. With the straight turbine blade, a difference of rotating velocity along the blade span may be ignored. For a straight blade, a blade profile at a midpoint along the blade span may be designed for angles of attack of the fluid flow and the rotating velocity at that point. However, that blade profile may be used along the entire blade (e.g., blade profiles with varying loading coefficients throughout the blade). Thus, blade angles may become too defensive near the shroud radius or too aggressive at near hub radius. In addition, the straight turbine blade may introduce early flow separations near the shroud radius or hub radius. Thus, total efficiency of the straight turbine blade may be limited. A constant chord length design may make the shroud radius relatively too short, thus leading, to a lower power export ability of the blade.

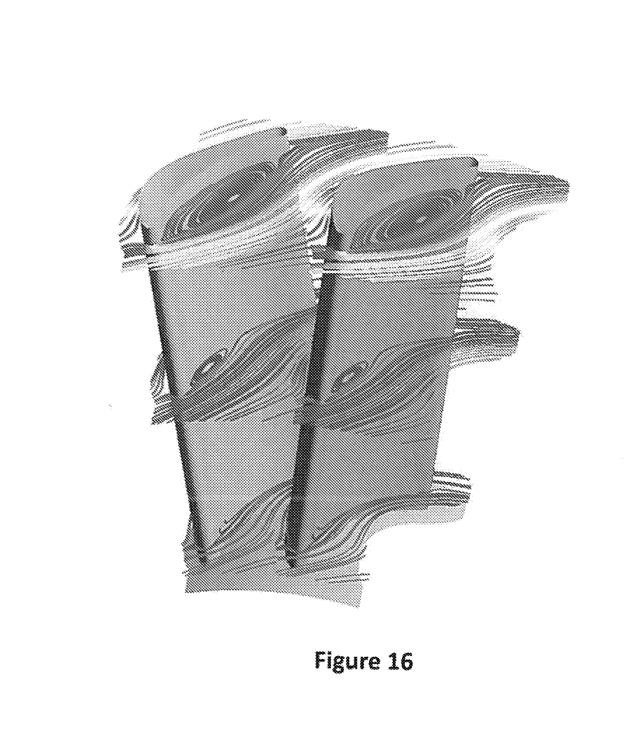

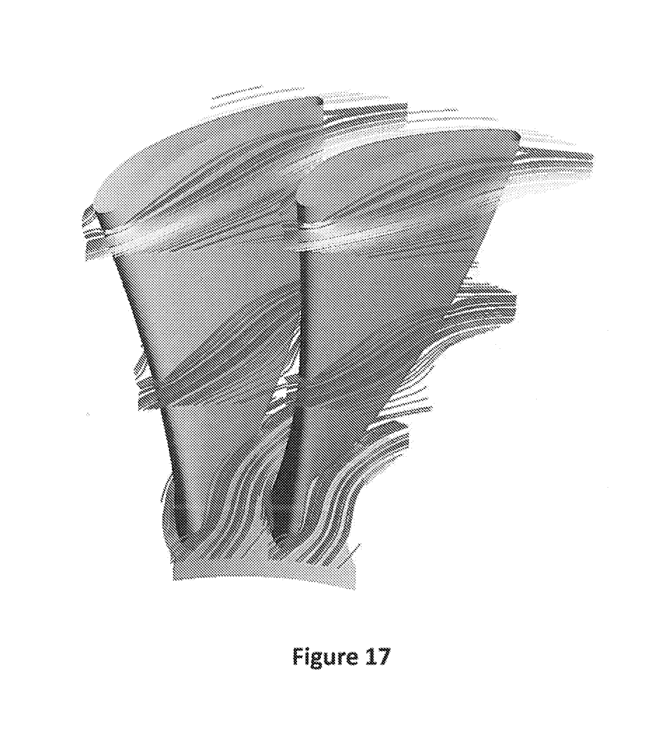

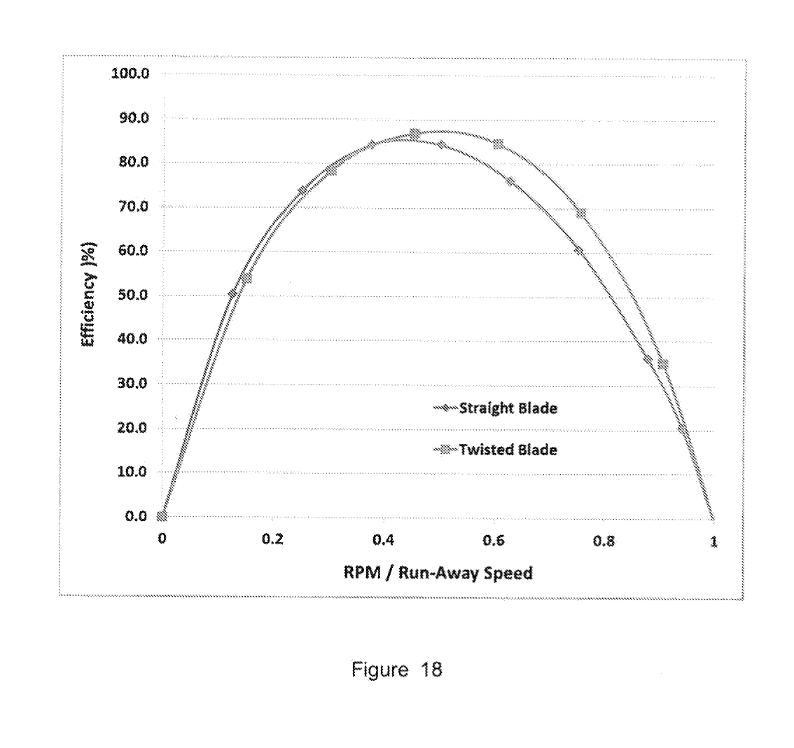

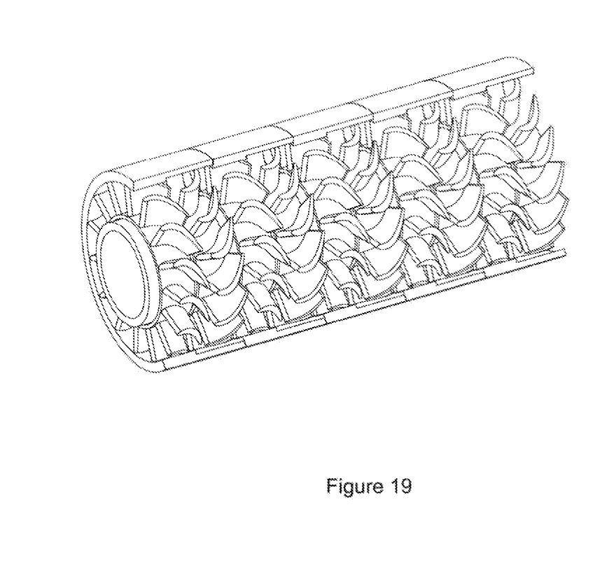

FIG. 16 illustrates flow separation for a straight turbine blade, and FIG. 17 illustrates a flow separation for a twisted turbine blade. FIG. 18 illustrate comparative graphs of efficiency between straight turbine blades and twisted turbine blades for a turbodrill diameter size of 2⅛ inch. FIG. 19 illustrates a portion of a turbodrill which includes turbine stages having twisted turbine blades.

While the foregoing, is directed to implementations of various techniques described herein, other and further implementations may be devised without departing from the basic scope thereof. Although the subject matter has been described in language specific to structural features and/or methodological acts, it is to be understood that the subject matter defined in the appended claims is not limited to the specific features or acts described above. Rather, the specific features and acts described above are disclosed as example forms of implementing one or more of the claims.

What is claimed is:

1. A turbodrill, comprising:
a housing having a bore extending at least partially therethrough;
a rotatable shaft disposed in the housing bore and rotatable relative to the housing, the housing, the housing bore and the rotatable shaft having a common longitudinal axis; and
a plurality of turbine blades disposed at least partially within the housing bore, at least one turbine blade of the plurality of turbine blades including:
a first blade profile disposed at a first point along a blade span; and
a second blade profile disposed at a second point along the blade span, the second blade profile differing from the first blade profile.

2. The turbodrill of claim 1, wherein the second blade profile differs from the first blade profile based on at least one profile parameter.

3. The turbodrill of claim 1, wherein a leading edge and a trailing edge of the at least one turbine blade are substantially linear.

4. The turbodrill of claim 1, wherein a leading edge and a trailing edge of the at least one turbine blade are nonlinear.

5. The turbodrill of claim 1, wherein the second blade profile differs from the first blade profile based on stagger angle.

6. The turbodrill of claim 1, wherein the plurality of turbine blades comprises one of a plurality of rotor blades and a plurality of stator blades.

7. The turbodrill of claim 1, wherein the plurality of turbine blades comprises both a plurality of rotor blades and a plurality of stator blades.

8. The turbodrill of claim 1, wherein a blade of the turbine blades has a pressure surface that is a concave shape.

9. The turbodrill of claim 1, wherein a blade of the turbine blades has a suction surface is a convex shape.

10. The turbodrill of claim 1, wherein a throat of the turbine blade is a minimum area in a passage between two consecutive turbine blades.

11. The turbodrill of claim 1, wherein a chord of a profile of a blade is determine(by a Zweifel's criterion.

12. A method, comprising:
pumping a volume of fluid with a pump;
containing the volume of the fluid within a defined area;
channeling at least a portion of the volume of the fluid through a turbodrill, wherein the turbodrill comprises:
a housing having a bore extending at least partially therethrough;
a rotatable shaft disposed in the housing bore and rotatable relative to the housing, the housing, the housing bore and the rotatable shaft having a common longitudinal axis; and
a plurality of turbine blades disposed at least partially within the housing bore, at least one turbine blade of the plurality of turbine blades including:
a first blade profile disposed at a first point along a blade span; and
a second blade profile disposed at a second point along the blade span, the second blade profile differing from the first blade profile.

13. The method according to claim 12, further comprising:
turning a drill bit through a connection with the turbodrill.

14. The method according to claim 12, further comprising:
returning the volume of fluid to the pump.
